(19) United States
(12) Patent Application Publication
(10) Pub. No.: US 2003/0081756 A1
(43) Pub. Date: May 1, 2003

(54) Multi-detector call classifier

(76) Inventors: Norman C. Chan, Louisville, CO (US); Douglas A. Spencer, Boulder, CO (US)

Correspondence Address: Docket Administrator (Room 1L-202), Avaya Inc., 101 Crawfords Corner Road, P.O. Box 629, Holmdel, NJ, 07733-3030, US

(21) Appl. No.: 10/037,583

(22) Filed: Oct. 23, 2001

(51) Int. Cl. H04M 3/00; H04M 5/00

(52) U.S. Cl. 379/243; 379/88.01

(57) ABSTRACT

Classifying a call to a called destination endpoint by a call classifier. The call classifier is responsive to information received from the called destination endpoint to perform the call classification.

### TECHNICAL FIELD

This invention relates to telecommunication systems in general, and in particular, to the capability of doing call classification.

### BACKGROUND OF THE INVENTION

Call classification is the ability of a telecommunications system to determine how a telephone call has been terminated at a called endpoint. An example of a termination signal that is received back for call classification purposes is a busy signal that is transmitted to the calling party upon the called party being already engaged in a telephone call. Another example is a reorder tone that is transmitted to the calling party by the telecommunication switching network if the calling party has made a mistake in the dialing the called party. Another example of a tone that has been used within the telecommunication network to indicate that a voice message will be played to the calling party is a special information tone (SIT) that is transmitted to the calling party before a recorded voice message is sent to the calling party. In the United States while the national telecommunication network was controlled by AT&T, call classification was straight forward because of the use of tones such as reorder, busy, and SIT codes. However, with the breakup of AT&T into Regional Bell Operating Companies and AT&T as only a long distance carrier, there has been a gradual shift away from well-defined standards for indicating the termination or disposition of a call. As the telecommunication switching network in the United States and other countries has become increasingly diverse and more and more new traditional and non-traditional network providers have begun to provide telecommunication services, the technology needed to perform call classification has greatly increased in complexity. This is due to the wide divergence in how calls are terminated in given network scenarios. The traditional tones that used to be transmitted to calling parties are rapidly being replaced with voice announcements both in conjunction with or without tones. In addition, the meaning associated with tones and/or announcements as well as the order in which they are presented is widely divergent. In addition, it is growing common for network service providers to replace the traditional tones such as busy tones with voice announcements. For example, the busy tone can be replaced with “the party you are calling is busy, if you wish to leave a message . . . ”

Call classification is used in conjunction with different types of services. For example, outbound-call-management, coverage of calls redirected off the net (CCRON), and call detail recording are services that require accurate call classification. Outbound-call management is concerned with when to add an agent to a call that has automatically been placed by an automatic call distribution center (also referred to as a telemarketing center) using predictive dialing. Predictive dialing is a method by which the automatic call distribution center automatically places a call to a telephone before an agent is assigned to handle that call. The accurate determination if a person has answered a telephone versus an answering machine or some other mechanism is important because the primary cost in an automatic call distribution center is the cost of the agents. Hence, every minute that can be saved by not utilizing an agent on a call, that has been for example answered by an answering machine, is actually money that the automatic call distribution center has saved. Coverage of calls redirected off net is concerned with various features that need accurate determination for the distribution of a call—i.e. whether a human has answered a call—in order to enable complex call coverage paths. Call detail recording is concerned with the accurate determination of whether a call has been completed to a person. This is a necessity in many industries. An example of such an industry is hotel/motel applications that utilize analog trunks to the switching network that do not provide answer supervision. It is necessary to accurately determine whether or not the call was completed to a person or a machine so as to accurately bill the user of the service within the hotel. Call detail recording is also concerned with the determination of different statuses of call termination such as hold status (e.g. music on hold), fax and/or modem tone duration.

Both the usability and the accuracy of the prior art call classification systems are decreasing since the existing call classifiers are unusable in many networking scenarios and countries. Hence, classification accuracy seen in many call center applications is rapidly decreasing.

Prior art call classifiers are based on the assumption about what kinds of information will be encountered in a given set of call termination scenarios. For example, this includes the assumption that special information tones (SIT) will proceed voice announcements and that analysis of speech content or meaning is not needed to accurately determine call termination states. The prior art cannot adequately cope with the rapidly expanding different types of call termination information that are observed by a call classifier in today's networking environment. Greatly increased complexity in a call classification platform are needed to handle the wide variety of termination scenarios which are encountered in today's domestic, international, wired, and wireless networks. The accuracy of the prior art call classifiers is diminishing rapidly in many networking environments.

### SUMMARY OF THE INVENTION

This invention is directed to solving these and other problems and disadvantages of the prior art. According to an embodiment of the invention, call classification is performed by using a multitude of inputs from a multitude of detectors. Advantageously, these detectors may be tone detection, zero crossing analysis, energy analysis, and automatic speech recognition. One skilled in the art would readily realize that other types of detectors could be used. Advantageously, an inference engine is utilized to accept the inputs from the multitude of detectors to make the call classification determination. Advantageously, the inference engine is a forward chaining engine, using inexact reasoning and utilizing an uniformed representation of knowledge and allowing the knowledge to be additive and modular. One skilled in the art would readily realize that other types of inference engines could be utilized.

These and other advantages and features of the present invention will become apparent from the following description of an illustrative embodiment of the invention taken together with the drawing.

### BRIEF DESCRIPTION OF THE DRAWING

FIG. 1 illustrates an example of the utilization of a call classifier in accordance with one embodiment of the invention;

FIG. 2 illustrates, in block diagram form, an embodiment of a call classifier in accordance with the invention;

FIG. 3 illustrates, in block diagram form, one embodiment of an automatic speech recognition block;

FIG. 4 illustrates, in block diagram form, an embodiment of a record and playback block;

FIG. 5 illustrates, in block diagram form, an embodiment of a tone detector;

FIG. 6 illustrates a high level block diagram an embodiment of an inference engine;

FIG. 7 illustrates, in block diagram, details of an implementation of an embodiment of the inference engine;

FIGS. 8-11 illustrate, in flowchart form, a second embodiment of an automatic speech recognition unit;

FIGS. 12 and 13 illustrate, in flowchart form, a third embodiment of an automatic speech recognition unit; and

FIGS. 14 and 15 illustrate, in flowchart form, a first embodiment of an automatic speech recognition unit.

### DETAILED DESCRIPTION

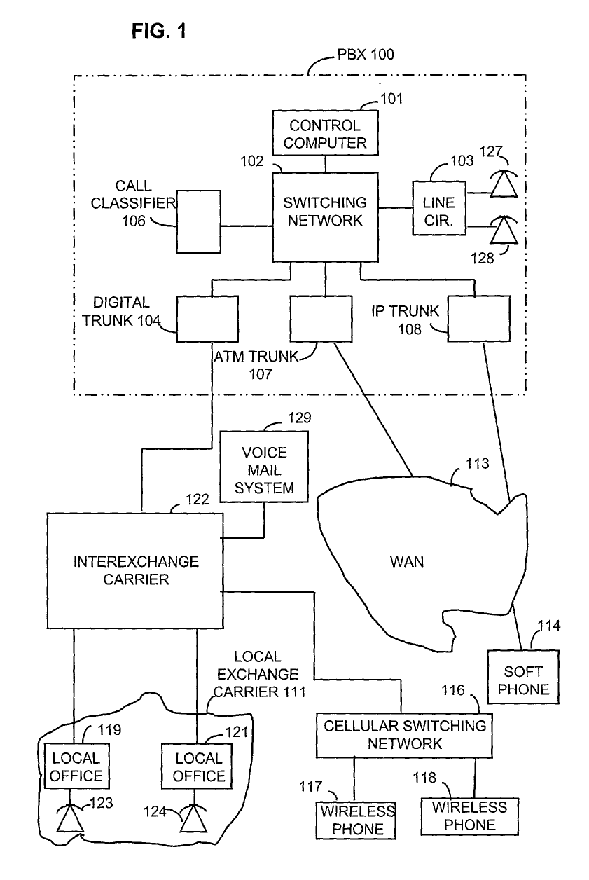

FIG. 1 illustrates a telecommunications system utilizing call classifier 106. As illustrated in FIG. 1, call classifier 106 is shown as being a part of PBX 100 (also referred to as a business communication system or enterprise switching system). However, one skilled in the art could readily see how to utilize call classifier 106 in interexchange carrier 122 or local offices 119 and 121, in cellular switching network 116, and in some portions of wide area network (WAN) 113. Also, one skilled in the art would readily realize that call classifier 106 can be a stand alone system external from all switching entities. Call classifier 106 is illustrated as being a part of PBX 100 as an example. As can be seen from FIG. 1, a telephone directly connected to PBX 100, such as telephone 127, can access a plurality of different telephones via a plurality of different switching units. PBX 100 comprises control computer 101, switching network 102, line circuits 103, digital trunk 104, ATM trunk 107, IP trunk 108, and call classifier 106. One skilled in the art would realize that while only digital trunk 104 is illustrated in FIG. 1, that PBX 100 could have analog trunks that could interconnect PBX 100 to local exchange carriers and to local exchanges directly. Also, one skilled in the art would readily realize that PBX 100 could have other elements.

To better understand the operation of the system of FIG. 1, consider the following example. Telephone 127 places a call to telephone 123 that is connected to local office 119, this call could be rerouted by interexchange carrier 122 or local office 119 to another telephone such as soft phone 114 or wireless phone 118. This rerouting would occur based on a call coverage path for telephone 123 or simply, if the user of telephone 127 miss dials. For example, prior art call classifiers were designed to anticipate that if interexchange carrier 122 redirected the call to voice mail system 129 as a result of call coverage, that interexchange carrier 122 would transmit the appropriate SIT tone or other known progress tones to PBX 100. However, in the modern telecommunication industry, interexchange carrier 122 is apt to transmit a branding message identifying the interexchange carrier. In addition, the call may well be completed from telephone 127 to telephone 123 however telephone 123 may employ an answering machine, and if the answering machine responds to the incoming call, call classifier 106 needs to identify this fact.

As is well known in the art, PBX 100 could well be providing automatic call distribution (ACD) functions and telephones 127 and 128 rather than being simple analog or digital telephones are actually agent positions, and PBX 100 is using predictive dialing to originate an outgoing call. To maximize the utilization of agent time, call classifier 106 has to correctly determine how the call has been terminated and in particular, whether or not a human has answered the call.

Another example of the utilization of PBX 100 is that PBX 100 is providing telephone services to a hotel. In this case, it is important that the outgoing calls be properly classified for purposes of call detail recording. Call classification is especially important if PBX 100 is connected via an analog trunk to the public switching network for providing service for the hotel.

A variety of messages for indicating busy or redirect messages can also be generated from cellular switching network 116 as is well known to not only those skilled in the art but the average user. Call classifier 106 has to be able to properly classify these various messages that will be generated by cellular switching network 116. In addition, telephone 127 may place a call via ATM trunk 107 or IP trunk 108 to soft phone 114 via WAN 113. WAN 113 can be implemented by a variety of vendors, and there is little standardization in this area. In addition, soft phone 114 is normally implemented by a personal computer which may be customized to suit the desires of the user, however, it may transmit a variety of tones and words indicating call termination back to PBX 100.

During the actual operation of PBX 100, call classifier 106 is used in the following manner. When control computer 101 receives a call set up message via line circuits 103 from telephone 127, it provides a switching path through switching network 102 and trunks 104, 107, or 108 to the destination endpoint. (Note, if PBX 100 is providing ACD functions, PBX 100 may use predictive dialing to automatically perform call set up with an agent being added later if a human answers the call.) In addition, control computer 101 determines whether the call needs to be classified with respect to the termination of the call. If control computer 101 determines that the call must be classified, control computer 101 transmits control information to call classifier 106 that it is to perform a call classification operation. Then, control computer 101 transmits control information to switching network 102 so that switching network 102 connects call classifier 106 into the call that is being established. One skilled in the art would readily realize that switching network 102 would only communicate voice signals associated with the call that were being received from the destination endpoint to call classifier 106. In addition, one skilled in the art would readily realize that control computer 101 may disconnect the talked path through switching network 102 from telephone 127 during call classification to prevent echoes being caused by audio information from telephone 127. Call classifier 106 classifies the call and transmits this information via switching network 102 to control computer 101. In response, control computer 101 transmits control information to switching network 102 so as to remove call classifier 106 from the call.

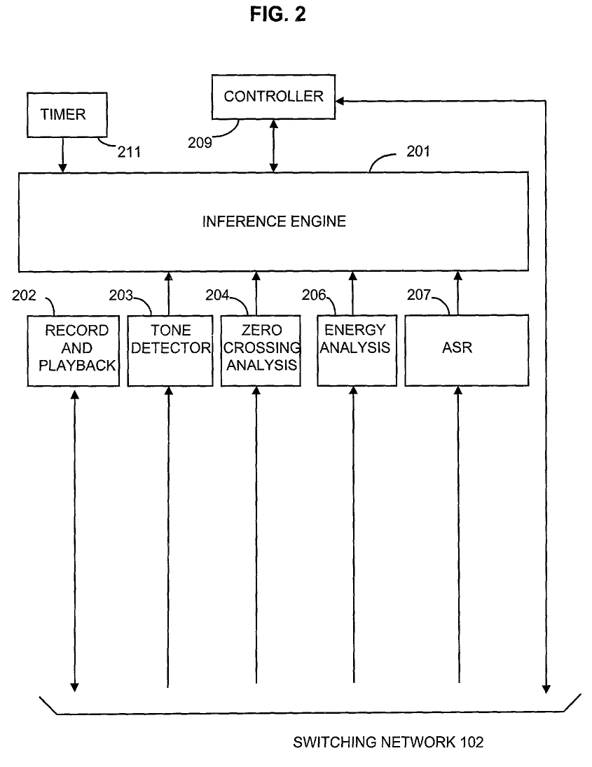

FIG. 2 illustrates one embodiment of call classifier 106 in accordance with the invention. Overall control of call classifier 106 is performed by controller 209 in response to control messages received from control computer 101. In addition, controller 209 is responsive to the results obtained by inference engine 201 to transmit these results to control computer 101. If necessary, one skilled in the art could readily see that an echo canceller could be used to reduce any occurrence of echoes in the audio information being received from switching network 102. Such an echo canceller could prevent severe echoes in the received audio information from degrading the performance of blocks 203-207.

A short discussion of the operations of blocks 202-207 is given in this paragraph. Each of these blocks is discussed in greater detail in later paragraphs. Record and playback block 202 is used to record audio signals being received from the called endpoint during the call classification operations of blocks 201 and 203-207. If the call is finally classified that a human answered, recorded playback block 202 plays the recorded voice of the human who answered the call at an accelerated rate to switching network 102 which directs the voice to a calling telephone such as telephone 127. Recorded playback block 202 continues to record voice until the accelerated playback of the voice has caught up with the answering human at the destination endpoint of the call in real time. At this point and time, record and playback block 202 signals controller 209 which in turn transmits a signal to control computer 101. Control computer 101 reconfigures switching network 102 so that call classifier 106 is no longer in the speech path between the calling telephone and the called endpoint. The voice being received from the called endpoint is then directly routed to the calling telephone or a dispatched agent if predictive dialing was used. Tone detection block 203 is utilized to detect the tones used within the telecommunication switching system. Zero crossing analysis block 204 also includes peak-to-peak analysis and is used to determine the presence of voice in an incoming audio stream of information. Energy analysis 206 is used to determine the presence of an answering machine and also to assist in the determination of tone detection. Automatic speech recognition (ASR) block 207 is described in greater detail in the following paragraphs.

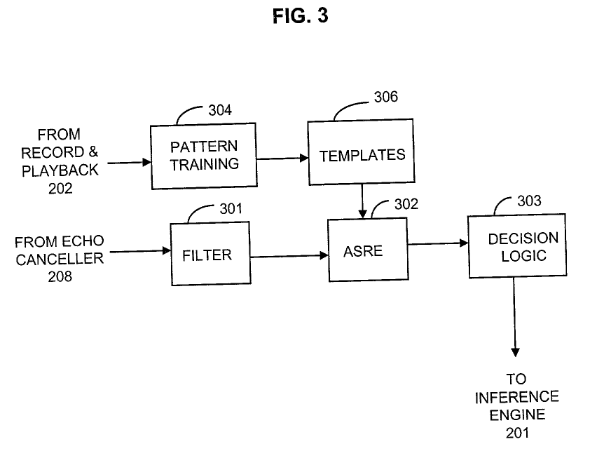

FIG. 3 illustrates, in block diagram form, greater details of ASR 207. Filter 301 receives the speech information from switching network 102 and performs filtering on this information utilizing techniques well known to those skilled in the art. The output of filter 301 is communicated to automatic speech recognizer engine (ASRE) 302. ASRE 302 is responsive to the speech information and a template defining the type of operation which is received from templates block 306 and performs phrase spotting so as to determine how the call has been terminated. To perform this operation, ASRE 302 is speaker independent since any large number of speakers can be at the destination endpoint. Further, ASRE 302 rejects irrelevant sounds: out-of-domain speech, background speech, background acoustic speech, and noise. ASRE 302 implements a small, limited domain vocabulary in which it is capable of performing phrase recognition. ASRE 302 is implementing a grammar of concepts. Where a concept may be a greeting, identification, price, time, results, action, etc. For example, one message that ASRE 302 searches for is “Welcome to AT&T wireless services . . . the cellular customer you have called is not available . . . or has traveled outside the coverage area . . . please try your call again later . . . ” Since AT&T Wireless Corporation may well vary this message from time to time only certain key phrases are attempted to be spotted. These key phrases are underlined. In this example, the phrase “Welcome . . . AT&T wireless” is the greeting, the phrase “customer . . . not available” is the result, the phrase “outside . . . coverage” is the cause, and the phrase “try . . . again” is the action. The concept that is being searched for is determined by the template that is received from block 306 which defines the grammar that is utilized by ASRE 302. An example of the grammar is given in the following Tables 1and 2:

TABLE 1

Line: = HELLO, silence
HELLO: = hello
HELLO: = hi
HELLO: = hey

The proceeding grammar illustration would be used to determine if a human being had terminated a call.

TABLE 2

answering_machine: - sorry | reached | unable.
sorry: - [i, am, sorry].
sorry: - [i'm, sorry].
sorry: - [sorry].
reached: - you, [reached].
you: - [you].
you: - [you, have].
you: - [you've].
unable: - some_one, not_able.
some_one: - [i].
some_one: - [i'm].
some_one: - [i, am].
some_one: - [we].
some_one: - [we, are].
not_able: - [not, able].
not_able: - [cannot]

The proceeding grammar illustration would be used to determine if an answering machine had terminated a call.

TABLE 3

Grammar_for SIT: = Tone, speech, <silence>
Tone: = [Freq_1_2, Freq_1_3, Freq_2_3]
speech: = [we, are, sorry].
speech: = [number, you, have, reached, is, not, in, service].
speech: = [your, call, cannot, be completed as, dialed].

The prceeding grammar illustration would be used as unified grammar for detecting if a record voice message was terminating the call.

The output of ASRE block 302 is transmitted to decision logic 303 which determines how the call is to be classified and transmits this determination to inference engine 301. One skilled in the art could readily envision other grammar constructs.

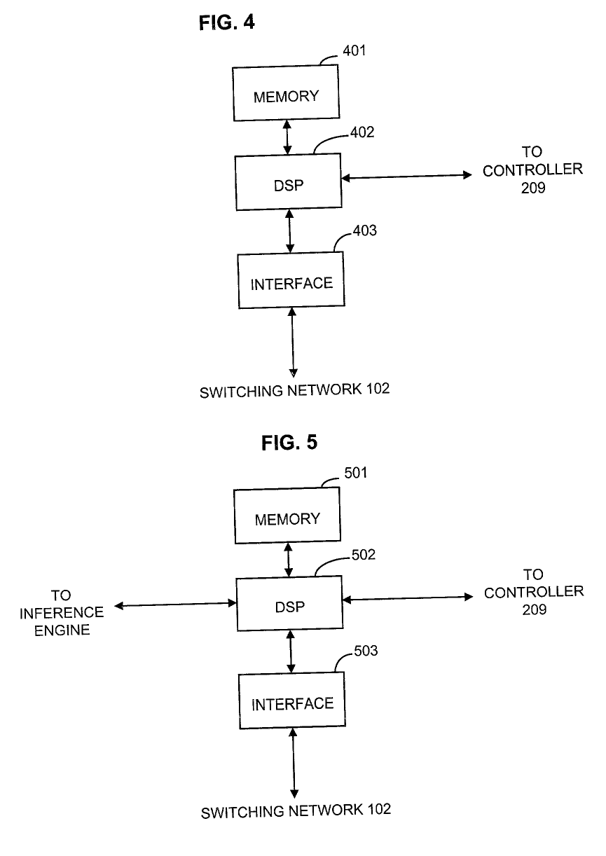

Consider now record and playback block 202. FIG. 4 illustrates, in block diagram form, details of record and playback block 202. Block 202 connects to switching network 102 via interface 403. A processor implements the functions of block 202 of FIG. 2 utilizing memory 401 for the storage of data and program. If additional calculation power is required, the processor block could include a digital signal processor (DSP). Although not illustrated in FIG. 2, processor 402 is interconnected to controller 209 for the communication of data and commands. When controller 209 receives control information from control computer 101 to begin call classification operations, controller 209 transmits a control message to processor 402 to start to receive audio samples via interface 403 from switching network 102. Interface 403 may well be implementing a time division multiplex protocol with respect to switching network 102. One skilled in the art would readily know how to design interface 403.

Processor 402 is responsive to the audio samples to store these samples in memory 401. When controller 209 receives a message from inference engine 201 that the call has been terminated with a human, controller 209 transmits this information to control computer 101. In response, control computer 101 arranges switching network 102 to accept audio samples from interface 403. Once switching network 102 has been rearranged, control computer 101 transmits a control message to controller 209 requesting that block 202 start the accelerated playing of the previously stored voice samples related to the call just classified. In response, controller 209 transmits a control message to processor 402. Processor 402 continues to receive audio samples from switching network 102 via interface 403 and starts to transmit the samples that were previously stored in memory 401 during the call classification period of time. Processor 402 transmits these samples at an accelerated rate until all of the voice samples have been transmitted including the samples that were received after processor 402 was commanded to start to transmit samples to switching network 102 by controller 209. This accelerated transmission is performed utilizing techniques such as eliminating a portion of silence interval between words or time domain harmonic scaling or other techniques well known to those skilled in the art. When all of the stored samples have been transmitted from memory 401, processor 402 transmits a control message to controller 209 which in turn transmits a control message to control computer 101. In response, control computer 101 rearranges switching network 102 so that the voice samples being received from the trunk involved in the call are directly transferred to the calling telephone without being switched to call classifier 106.

Another function that is performed by record and playback 202 is to save audio samples that inference engine 201 can not classify. Processor 402 starts to save audio samples (could also be other types of samples) at the start of the classification operation. If inference engine 201 transmits a control message to controller 209 stating that inference engine 201 is unable to classify the termination of the call within a certain confidence level, controller 209 transmits a control message to processor 402 to retain the audio samples. These audio samples are then analyzed by pattern training block 304 of FIG. 3 so that the templates of block 306 can be updated to assure the classification of this type of termination. Note, that pattern training block 304 may be implemented either manually or automatically as is well known by those skilled in the art.

Consider now tone detector 203. FIG. 5 illustrates, in block diagram form, greater details of tone detector 203 of FIG. 2. Processor 502 receives audio samples from switching network 102 via interface 503, communicates command information and data with controller 209 and transmits the results of the analysis to inference engine 201. If additional calculation power is required, processor block 502 could include a DSP. Processor 502 utilizes memory 501 to store program and data. In order to perform tone detection, processor 502 both analyzes frequencies being received from switching network 102 and timing patterns. For example, a set of timing patterns may indicate that the cadence is that of ringback. Tones such as ring back, dial tone, busy tone, reorder tone, etc. have definite timing patterns as well as defined frequencies. The problem is that the precision of the frequencies used for these tones is not always good. The actual frequencies can vary greatly. To detect these types of tones, processor 502 implements the timing pattern analysis using techniques well known to those skilled in the art. For tones such as SIT, modem, fax, etc., processor 502 uses frequency analysis. For the frequency analysis, processor 502 advantageously utilizes Goertzel algorithm which is a type of Discrete Fourier transform. One skilled in the art readily knows how to implement the Goertzel algorithm on processor 502 and to implement other algorithms for the detection of frequency. Further, one skilled in the art would readily realize that a digital filter could be used. When processor 502 is instructed by controller 209 that call classification is taking place, it receives audio samples from switching network 102 and processes this information utilizing memory 501. Once processor 502 has determined the classification of the audio samples, it transmits this information to inference engine 201. Note, processor 502 will also indicate to inference engine 201 the confidence that processor has attached to its call classification determination.

Consider now in greater detail energy analysis block 206 of FIG. 2. Energy analysis block 206 could be implemented by an interface, processor, and memory similar to that shown in FIG. 5 for tone detector 203. Using well known techniques for detecting the energy in audio samples, energy analysis block 206 is used for answering machine detection, silence detection, and voice activity detection. Energy analysis block 206 performs answering machine detection by looking for the cadence in energy being received back in the voice samples. For example, if the energy of audio samples being received back from the destination endpoint is a high burst of energy that could be the word “hello” and then, followed by low energy of the audio samples that could be “silence”, energy analysis block 206 determines that an answering machine has not responded to the call but rather a human has. However, if the energy being received back in the audio samples appears to be how words would be spoken into an answering machine for a message, energy analysis block 206 determines that this is an answering machine. Silence detection is performed by simply observing the audio samples over a period of time to determine the amount of energy activity. Energy analysis block 206 performs voice activity detection in a similar manner to that done in answering machine detection. One skilled in the art would readily know how to implement these operations on a processor.

Consider now in greater detail zero crossing analysis block 204. This block is implemented on similar hardware to that shown in FIG. 5 for tone detector 203. Zero crossing analysis block 204 not only performs zero crossing analysis but also utilizes peak-to-peak analysis. There are numerous techniques for performing zero crossing and peak to peak analysis all of which are well known to those skilled in the art. One skilled in the art would know how to implement zero crossing and peak-to-peak analysis on a processor similar to processor 502 of FIG. 5. Zero crossing analysis block 204 is utilized to detect speech, tones, and music. Since voice samples will be composed of unvoiced and voiced segments, zero crossing analysis block 204 can determine this unique pattern of zero crossings utilizing the peak to peak information to distinguish voice from those audio samples that contain tones or music. Tone detection is performed by looking for periodically distributed zero crossings utilizing the peak-to-peak information. Music detection is more complicated, and zero crossing analysis block 204 relies on the fact that music has many harmonics which result in a large number of zero crossings in comparison to voice or tones.

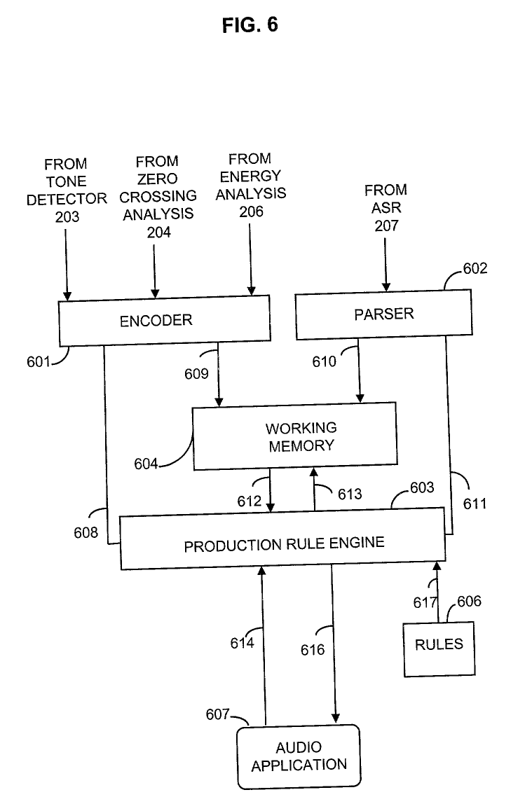

FIG. 6 illustrates an embodiment for the inference engine. FIG. 6 is utilized with all of the embodiments of ASR block 207. With respect to FIG. 6, when the inference engine of FIG. 6 is utilized with the first embodiment of ASR block 207, it is receiving only word phonemes from ASR block 207; however, when it is working with the second and third embodiments of ASR block 207, it receives both word and tone phonemes. When inference engine 201 is used with the second embodiment of ASR block 207, parser 602 receives word phonemes and tone phonemes on separate message paths from ASR block 207 and processes the word phonemes and the tone phonemes as separate audio streams. In the third embodiment, parser 602 receives the word and tones phonemes on a single message path from ASR block 207 and processes combined word and tone phonemes as one audio stream.

Encoder 601 receives the outputs from the simple detectors which are blocks 203, 204, and 206 and converts these outputs into facts that are stored in working memory 604 via path 609. The facts are stored in production rule format.

Parser 602 receives only word phonemes for the first embodiment of ASR block 207, word and tone phonemes as two separate audio streams in the second embodiment of ASR block 207, and word and tone phonemes as a single audio stream in the third embodiment of block 207. Parser 602 receives the phonemes as text and uses a grammar that defines legal responses to determine facts that are then stored in working memory 604 via path 610. An illegal response causes parser 602 to store an unknown as a fact in working memory 604. When both encoder 601 and parser 602 are done, they send start commands via paths 608 and 611, respectively, to production rule engine (PRE) 603.

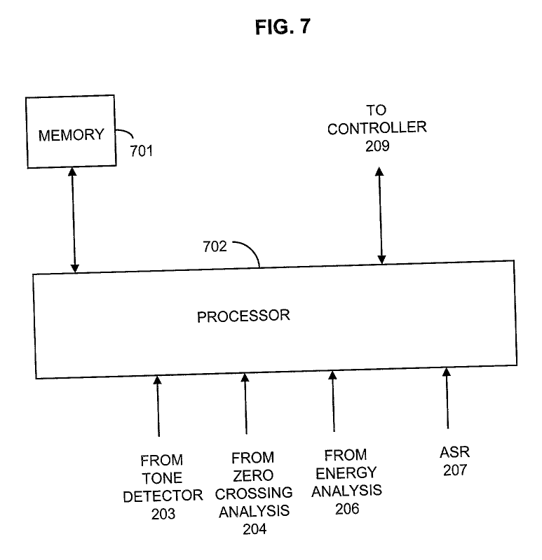

Production rule engine 603 takes the facts (evidence) via path 612 that has been stored in working memory 604 by encoder 601 and parser 602 and applies the rules stored in 606. As rules are applied, some of the rules will be activated causing facts (assertions) to be generated that are stored back in working memory 604 via path 613 by production rule engine 603. On another cycle of production rule engine 603, these newly stored facts (assertions) will cause other rules to be activated. These other rules will generate additional facts (assertions) that may inhibit the activation of earlier activated rules on a later cycle of production rule engine 603. Production rule engine 603 is utilizing forward chaining. However, one skilled in the art would readily realize that production rule engine 603 could be utilizing other methods such as backward chaining. The production rule engine continues the cycle until no new facts (assertions) are being written into memory 604 or until it exceeds a predefined number of cycles. Once production rule engine has finished, it sends the results of its operations to audio application 607. As is illustrated in FIG. 7, blocks 601-607 are implemented on a common processor. Audio application 607 then sends the response to controller 209.

An example of a rule or grammar that would be stored in rules block 606 and utilized by production rule engine 603 is illustrated in Table 4 below:

TABLE 4
/* Look for spoofing answering machine */
IF tone(sit_reorder) and parser(answering_machine) and request(amd)
THEN assert (got_a_spoofing_answering_machine).
/* look for answering machine leave message request */
IF tone(bell_tone) and parser(answering_machine) and
request(leave_message) THEN
assert(answering_machine_ready_to_take_message).

FIG. 7 illustrates advantageously one hardware embodiment of inference engine 201. One skilled in the art would readily realize that inference engine could be implement in many different ways including wired logic. Processor 702 receives the classification results or evidence from blocks 203-207 and processes this information utilizing memory 701 using well-established techniques for implementing an inference engine based on the rules. The rules are stored in memory 701. The final classification decision is then transmitted to controller 209.

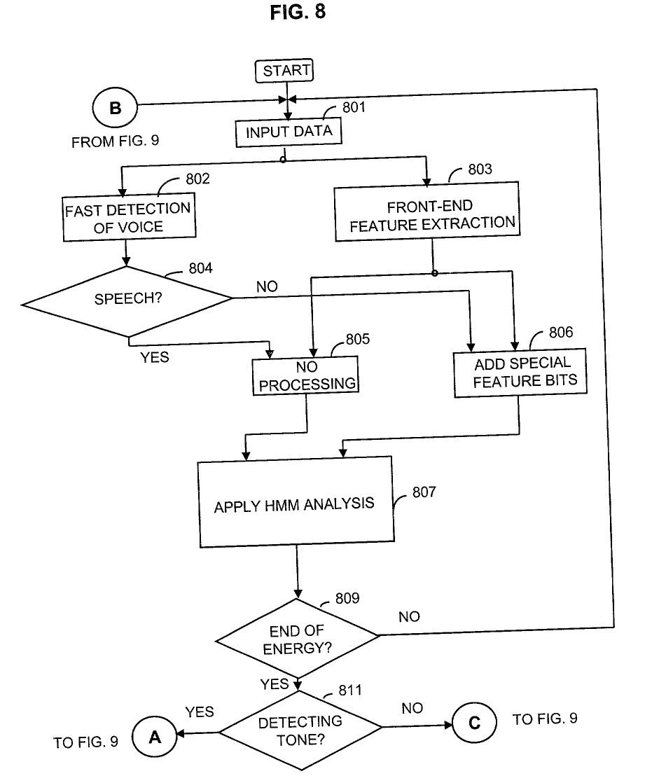

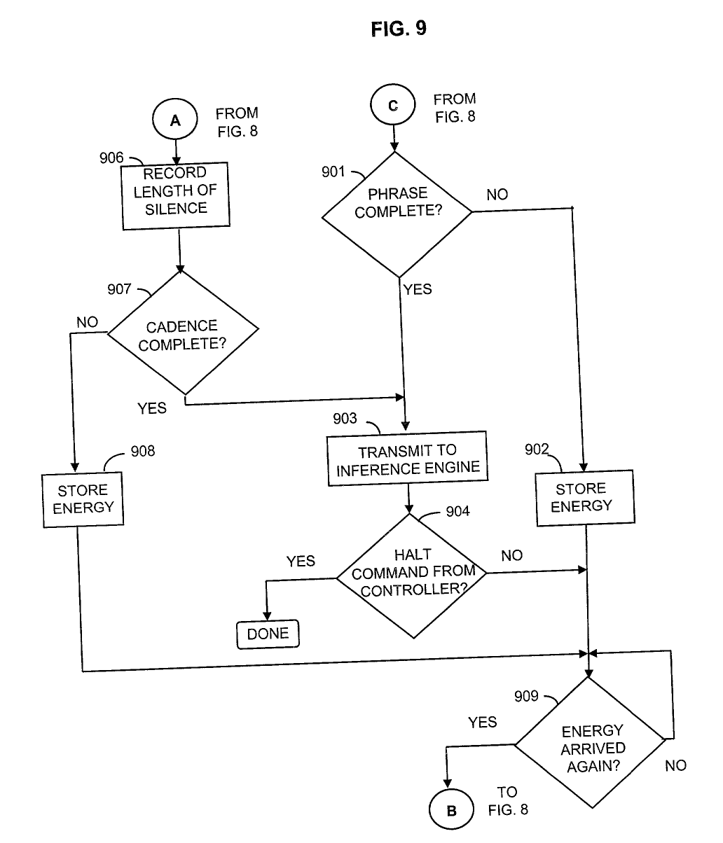

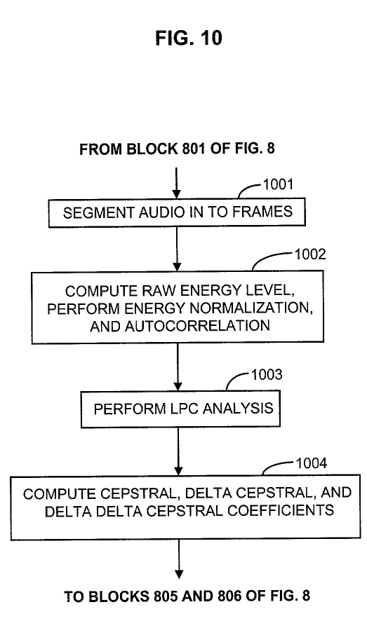

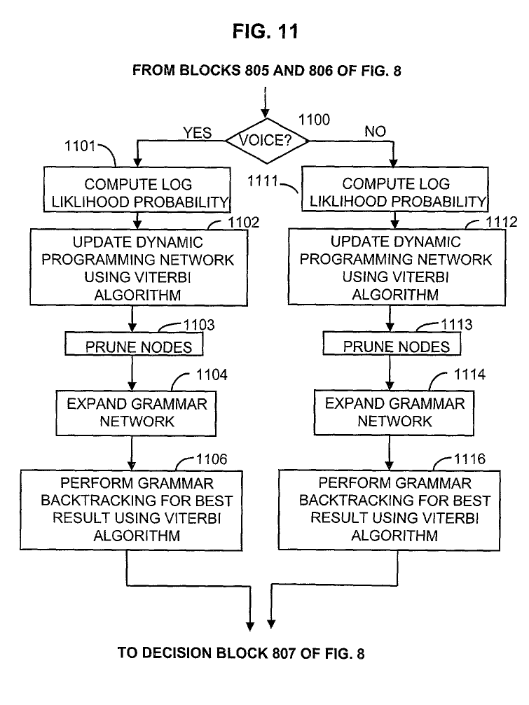

The second embodiment of block 207 is illustrated, in flowchart form, in FIGS. 8 and 9. One skilled in the art would readily realize that other embodiments could be utilized. Block 801 accepts 10 milliseconds of framed data from switching network 102. This information is in 16 bit linear input form in the present embodiment. However, one skilled in the art would readily realize that the input could be in any number of formats including but not limited to 16 bit or 32 bit floating point. This data is then processed in parallel by blocks 802 and 803. Block 802 performs a fast speech detection analysis to determine whether the information is a speech or a tone. The results of block 802 are transmitted to decision block 804. In response, decision block 804 transmits a speech control signal to block 805 or a tone control signal to block 806. Block 803 performs the front-end feature extraction operation which is illustrated in greater detail in FIG. 10. The output from block 803 is a full feature vector. Block 805 is responsive to this full feature vector from block 803 and a speech control signal from decision block 804 to transfer the unmodified full feature vector to block 807. Block 806 is responsive to this full feature vector from block 803 and a tone control signal from decision block 804 to add special feature bits to the full feature vector identify it as a vector that contains a tone. The output of block 806 is transferred to block 807. Block 807 performs a Hidden Markov Model (HMM) analysis on the input feature vectors. One skilled in the art would readily realize that other alternatives to HMM could be used such as Neural Net analysis. Block 807 as can be seen in FIG. 11 actually performs one of two HMM analysis depending on whether the frames were designated as speech or tone by decision block 804. Every frame of data is analyzed to see whether an end-point is reached. Until the end-point is reached, the feature vector is compared with a stored trained data set to find the best match. After execution of block 807, decision block 809 determines if an end-point has been reached. An end-point is a change in energy for a significant period of time. Hence, decision block 809 detects the end of the energy. If the answer in decision block 809 is no, control is transferred back to block 801. If the answer in decision block 809 is yes, control is transferred to decision block 811 which determines if decoding is for a tone rather than speech. If the answer is no, control is transferred to decision block 901 of FIG. 9.

Decision block 901 determines if a complete phrase has been processed. If the answer is no, block 902 stores the intermediate energy and transfers control to decision block 909 which determines when energy is being processed again. When energy is detected, decision block 909 transfers control to block 801 FIG. 8. If the answer in decision block 901 is yes, block 903 transmits the phrase to inference engine 201. Decision block 904 then determines if a command has been received from controller 209 indicating that the process should be halted. If the answer is no, control is transferred back to block 909. If the answer is yes, no further operations are performed until restarted by controller 209.

Returning to decision block 811 of FIG. 8, if the answer is yes that tone decoding is being performed, control is transferred to block 906 of FIG. 9. Block 906 records the length of silence until new energy is received before transferring control to decision block 907 which determines if a cadence has been processed. If the answer is yes, control is transferred to block 903. If the answer is no, control is transferred to block 908. Block 908 stores the intermediate energy and transfers control to decision block 909.

Block 803 is illustrated in greater detail, in flowchart for, in FIG. 10. Block 1001 receives 10 milliseconds of audio data from block 801. Block 1001 segments this audio data into frames. Block 1002 is responsive to the audio frames to compute the raw energy level, perform energy normalization, and autocorrelation operations all of which are well known to those skilled in the art. The result from block 1002 is then transferred to block 1003 which performs linear predictive coding (LPC) analysis to obtain the LPC coefficients. Using the LPC coefficients, block 1004 computes the Cepstral, Delta Cepstral, and Delta Delta Cepstral coefficients. The result from block 1004 is the full feature vector which is transmitted to blocks 805 and 806.

Block 807 is illustrated in greater detail in FIG. 11. Decision block 1100 makes the initial decision whether the information is to be processed as a speech or a tone utilizing the information that was inserted or not inserted into the full feature vector in blocks 806 and 805, respectively, of FIG. 8. If the decision is that it is voice, block 1101 computes the log likelihood probability that the phonemes of the vector compare to phonemes in the built-in grammar. Block 1102 then takes the result from 1101 and updates the dynamic programming network using the Viterbi algorithm based on the computed log likelihood probability. Block 1103 then prunes the dynamic programming network so as to eliminate those nodes that no longer apply based on the new phonemes. Block 1104 then expands the grammar network based on the updating and pruning of the nodes of the dynamic programming network by blocks 1102 and 1103. It is important to remember that the grammar defines the various words and phrases that are being looked for; hence, this can be applied to the dynamic programming network. Block 1106 then performs grammar backtracking for the best results using the Viterbi algorithm. A potential result is then passed to block 809 for its decision.

Blocks 1111 through 1116 perform similar operations to those of blocks 1101 through 1106 with the exception that rather than using a grammar based on what is expected as speech, the grammar defines what is expected in the way of tones. In addition, the initial dynamic programming network will also be different.

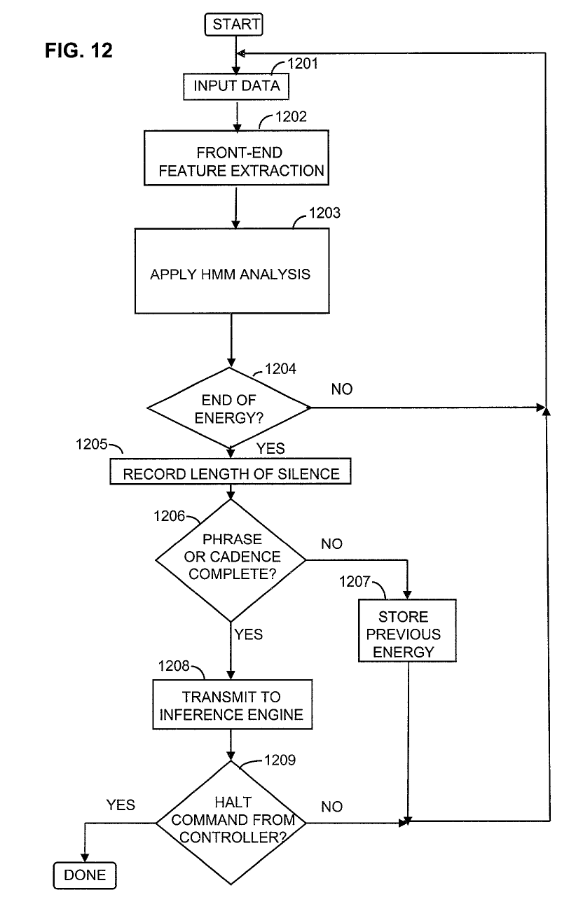

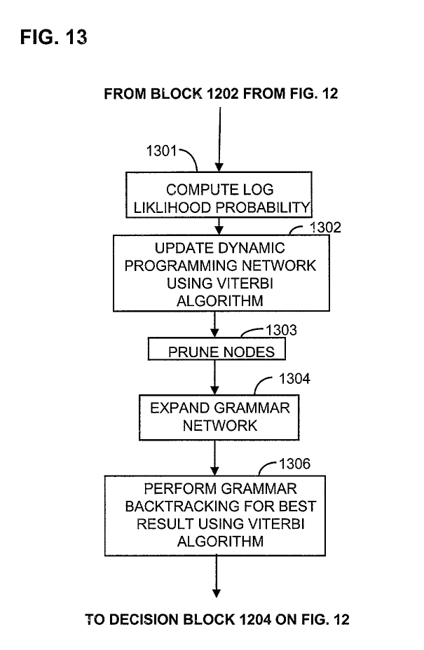

FIG. 12 illustrates, in flowchart form, the third embodiment of block 207. Since in the third embodiment speech and tones are processed in the same HMM analysis, there is no equivalent blocks for block 802, 804, 805, and 806 in FIG. 12. Block 1201 accepts 10 milliseconds of framed data from switching network 102. This information is in 16 bit linear input form. This data is processed by block 1202. The results from block 1202 (which performs similar actions to those illustrated in FIG. 10) are transmitted as a full feature vector to block 1203. Block 1203 is receiving the input feature vectors and performing a HMM analysis utilizing a unified model for both speech and tones. Every frame of data is analyzed to see whether an end-point is reached. (In this context, an end-point is a period of low energy indicating silence.) Until the end-point is reached, the feature vector is compared with the stored trained data set to find the best match. Greater details on block 1203 are illustrated in FIG. 13. After the operation of block 1203, decision block 1204 determines if an end-point has been reached which is a period of low energy indicating silence. If the answer in no, control is transferred back to block 1201. If the answer is yes, control is transferred to block 1205 which records the length of the silence before transferring control to decision block 1206. Decision block 1206 determines if a complete phrase or cadence has been determined. If it has not, the results are stored by block 1207, and control is transferred back to block 1201. If the decision is yes, then the phrase or cadence designation is transmitted on a unitary message path to inference engine 201. Decision block 1209 then determines if a halt command has been received from controller 209. If the answer is yes the processing is finished. If the answer is no, control is transferred back to block 1201.

FIG. 13 illustrates, in flowchart form, greater details of block 1203 of FIG. 12. Block 1301 computes the log likelihood probability that the phonemes of the vector compare to phonemes in the built-in grammar. Block 1302 then takes the result from 1301 and updates the dynamic programming network using the Viterbi algorithm based on the computed log likelihood probability. Block 1303 then prunes the dynamic programming network so as to eliminate those nodes that no longer apply based on the new phonemes. Block 1304 then expands the grammar network based on the updating and pruning of the nodes of the dynamic programming network by blocks 1302 and 1303. It is important to remember that the grammar defines the various words and phrases that are being looked for; hence, this can be applied to the dynamic programming network. Block 1306 then performs grammar backtracking for the best results using the Viterbi algorithm. A potential result is then passed to block 1204 for its decision.

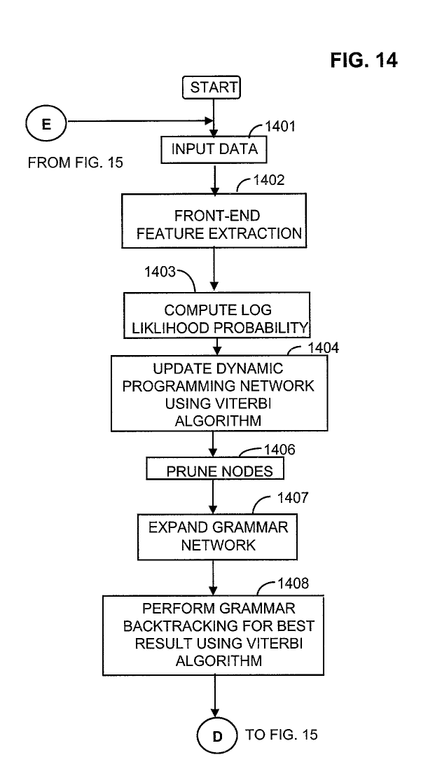

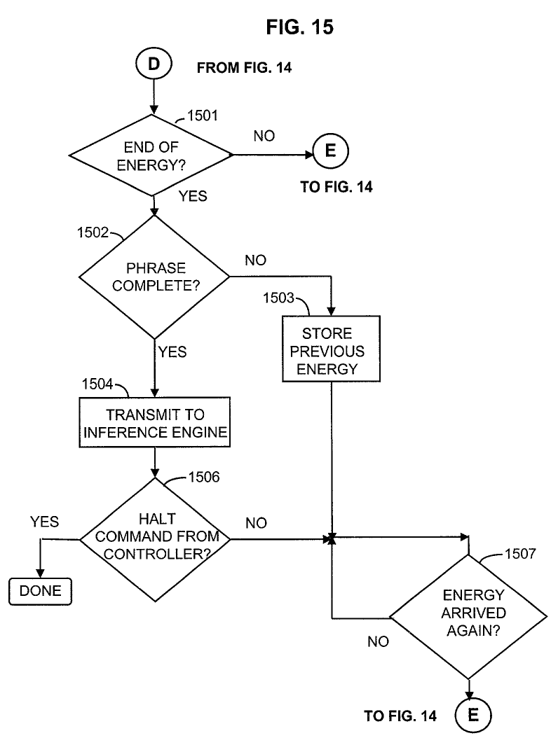

FIGS. 14 and 15 illustrate, in block diagram form, the first embodiment of ASR block 207. Block 1401 of FIG. 14 accepts 10 milliseconds of framed data from switching network 102. This information is in 16 bit linear input form. This data is processed by block 1402. The results from block 1402 (which perform similar actions to those illustrated in FIG. 10) are transmitted as a full feature vector to block 1403. Block 1403 computes the log likelihood probability that the phonemes of the vector compare to phonemes in the built-in speech grammar. Block 1404 then takes the result from 1402 and updates the dynamic programming network using the Viterbi algorithm based on the computed log likelihood probability. Block 1406 then prunes the dynamic programming network so as to eliminate those nodes that no longer apply based on the new phonemes. Block 1407 then expands the grammar network based on the updating and pruning of the nodes of the dynamic programming network by blocks 1404 and 1406. It is important to remember that the grammar defines the various words that are being looked for; hence, this can be applied to the dynamic programming network. Block 1408 then performs grammar backtracking for the best results using the Viterbi algorithm. A potential result is then passed to decision block 1501 of FIG. 15 for its decision.

Decision block 1501 determines if an end-point has been reached which is indicated by a period of low energy. If the answer in no, control is transferred back to block 1401. If the answer is yes in decision block 1501, decision block 1502 determines if a complete phrase has been determined. If it has not, the results are stored by block 1503, and control is transferred to decision block 1507 which determines when energy arrives again. Once energy is determined, decision block 1507 transfers control back to block 1401 of FIG. 14. If the decision is yes in decision block 1502, then the phrase designation is transmitted on a unitary message path to inference engine 201 by block 1504 before transferring control to decision block 1506. Decision block 1506 then determines if a halt command has been received from controller 209. If the answer is yes, the processing is finished. If the answer in no in decision block 1506, control is transferred to block 1507.

Whereas, blocks 201-207 have been disclosed as each executing on a separate DSP or processor, one skilled in the art would readily realize that one processor of sufficient power could implement all of these blocks. In addition, one skilled in the art would realize that the functions of these blocks could be subdivided and be performed by two or more DSPs or processors.

Of course, various changes and modifications to the illustrative embodiment described above will be apparent to those skilled in the art. Such changes and modifications can be made without departing from the spirit and scope of the invention and without diminishing its intended advantages. It is therefore intended that such changes and modifications be covered by the following claims except in so far as limited by the prior art.

What is claimed is:

1. An apparatus for classifying a call to a destination endpoint comprising:
a receiver for receiving information from the destination endpoint;
a first detector for determining a first classification in response to the information received from the destination endpoint;
a second detector for determining a second classification in response to the information received from the destination endpoint;
a third detector for determining a third classification in response to the information received from the destination endpoint; and
an inference engine for determining a call classification of the destination endpoint in response to the first, second, and third classifications.

2. The apparatus of claim 1 further comprises a fourth detector for determining a fourth classification in response to the information received from the destination endpoint; and
the inference engine further responsive to the fourth classification for determining the call classification of the destination endpoint.

3. The apparatus of claim 1 wherein the first detector is a tone detector.

4. The apparatus of claim 1 wherein the second detector is an energy analyzer.

5. The apparatus of claim 1 wherein the third detector is a zero crossing analyzer.

6. The apparatus of claim 2 wherein the fourth detector is an automatic speech recognizer.

7. The apparatus of claim 6 further comprises a recorder for recording the received information and for updating the inference engine.

8. The apparatus of claim 2 wherein the first detector is a tone detector, the second detector is an energy analyzer, and third detector is a zero crossing analyzer;

9. The apparatus of claim 8 wherein the fourth detector is an automatic speech recognizer.

10. A call classifier for classifying a call to a destination endpoint comprising:
a circuit for receiving information from the destination endpoint and for processing the received information;
a tone detector for determining a first classification in response to the processed information;
a energy analyzer detector for determining a second classification in response to the processed information;
a zero crossing analyzer detector for determining a third classification in response to the processed information; and
an inference engine for determining a call classification of the destination endpoint in response to the first, second, and third classifications.

11. The call classifier of claim 10 further comprises a recorder for recording the received information and for updating the inference engine.

12. A call classifier for classifying a call to a destination endpoint comprising:
a circuit for receiving information from the destination endpoint and for processing the received information;
a tone detector for determining a first classification in response to the processed information;
a energy analyzer detector for determining a second classification in response to the processed information;
a zero crossing analyzer detector for determining a third classification in response to the processed information;
an automatic speech recognition unit for determining a fourth classification; and
an inference engine for determining a call classification of the destination endpoint in response to the first, second, third and fourth classifications.

13. The call classifier of claim 12 further comprises a recorder for recording the received information and for updating the inference engine.

14. The call classifier of claim 12 wherein the automatic speech recognition unit is determining words.

15. The call classifier of claim 12 wherein the automatic speech recognition unit is determining phrases.

16. The call classifier of claim 15 wherein the automatic speech recognition unit is executing a Hidden Markov Model.

17. A method for classifying a call to a destination endpoint, comprising the steps of:
receiving information from the called destination endpoint;
performing a first classification of the received information;
performing a second classification of the received information;
performing a third classification of the received information; and
determining a call classification of the called destination endpoint from the first, second, and third classifications.

18. The method of claim 17 further comprises the step of performing a fourth classification of the received information; and
the step of determining further responsive to the fourth classification to determine the call classification of the called destination endpoint.

19. The method of claim 18 wherein the first classification is for one of tone, energy, zero crossings, or speech.

20. The method of claim 19 wherein the second classification is for one of tone, energy, zero crossings, or speech.

21. The method of claim 19 wherein the third classification is for one of tone, energy, zero crossings, or speech.

22. The method of claim 21 wherein the fourth classification is for one of tone, energy, zero crossings, or speech.

23. The method of claim 22 wherein the step of determining comprises the step of executing an inference engine.

24. The method of claim 23 further comprises the step of recording the received information for updating the inference engine.

25. The method of claim 23 wherein performing classification for speech comprises the step of executing a Hidden Markov Model.

26. The method of claim 23 wherein performing classification for speech comprises the step of determining words.

27. The method of claim 23 wherein performing classification for speech comprises the step of determining phrases.

28. A method for classifying a call to a destination endpoint, comprising the steps of:
receiving information from the called destination endpoint;
performing a tone classification of the received information;
performing a energy classification of the received information;
performing a zero crossing classification of the received information;
performing speech classification of the received information; and
executing an inference engine to determine a call classification of the called destination endpoint from the tone, energy, zero crossing, and speech classifications.

29. The method of claim 28 wherein performing speech classification comprises the step of determining words.

30. The method of claim 28 wherein performing speech classification comprises the step of determining phrases.

31. The method of claim 28 further comprises the step of recording the received information for updating the inference engine.

32. Apparatus for implementing the steps of claim 17.

33. Apparatus for implementing the steps of claim 18.
